(19) United States
(12) Patent Application Publication
(10) Pub. No.: US 2005/0094729 A1
(43) Pub. Date: May 5, 2005

(54) Software and hardware partitioning for multi-standard video compression and decompression

(75) Inventors: John Yuan, Austin, TX (US); Steven Smith, Austin, TX (US); Srikrishna Ramaswamy, Austin, TX (US); Zheng Luo, Austin, TX (US)

Correspondence Address: Raffi Gostanian, Jr.;RG&Associates, 1103 Twin Creeks Drive, Allen, TX, 75013, US

(73) Assignee: VisionFlow, Inc., Austin, TX (US)

(21) Appl. No.: 10/913,574

(22) Filed: Aug. 6, 2004

Related U.S. Application Data
(60) Provisional application No. 60/499,223, filed on Aug. 29, 2003.
(60) Provisional application No. 60/493,508, filed on Aug. 8, 2003.
(60) Provisional application No. 60/493,509, filed on Aug. 8, 2003.

(51) Int. Cl. H04N 7/12

(52) U.S. Cl. 375/240.16; 375/240.03; 375/240.18; 375/240.12

(57) ABSTRACT

A system, method, and computer readable medium adapted to provide software and hardware partitioning for multi-standard video compression and decompression comprises a master-slave bus, a peer-to-peer bus, and an inter-processor communications bus, a prediction engine, a filter engine, and a transform engine, and a video encode control processor, and a video decode control processor adapted to utilize the master-slave bus to interact with the video hardware engines for control flow processing, the peer-to-peer bus for data flow processing, and the inter-processor communications bus for inter-processor communications, and a system data bus adapted to permit data exchange between system resources, the busses, the engines, and the processors.

### CROSS REFERENCE TO RELATED APPLICATIONS

The present patent application claims the benefit of commonly assigned U.S. Provisional Patent Application No. 60/499,223, filed on Aug. 29, 2003, entitled DESIGN PARTITION BETWEEN SOFTWARE AND HARDWARE FOR MULTI-STANDARD VIDEO DECODE AND ENCODE and U.S. Provisional Patent Application No. 60/493,508, filed on Aug. 8, 2003, entitled SOFT-CHIP SOFTWARE-DRIVEN SYSTEM ON A CHIP ARCHITECTURE, and is related to commonly assigned U.S. Provisional Patent Application No. 60/493,509, filed on Aug. 8, 2003, entitled BANDWIDTH-ON-DEMAND: ADAPTIVE BANDWIDTH ALLOCATION OVER HETEROGENEOUS SYSTEM INTERCONNECT and to U.S. Patent Application Docket No. VisionFlow.00002, entitled ADAPTIVE BANDWIDTH ALLOCATION OVER A HETEROGENEOUS SYSTEM INTERCONNECT DELIVERING TRUE BANDWIDTH-ON-DEMAND, filed on even date herewith, the teachings of which are incorporated by reference herein.

### BACKGROUND OF THE INVENTION

Overview

The present invention is generally related to video compression and decompression, and, more specifically, to software and hardware partitioning for multi-standard video compression and decompression (or encode and decode). The current invention exploits the similarities of several video standards, namely H.264/AVC (MPEG-4 Part 10) and MPEG-4, to offer a flexible and efficient software-driven silicon platform architecture.

There are various challenges currently facing the video industry and video compression and decompression applications. For example, the compression with mainstream standards (MPEG-4, MPEG-2, H.263/1, etc.) is insufficient. Emerging applications, such as high definition video applications (HDTV, HD-DVD), or bandwidth-sensitive mobile applications require more efficient compression for greater savings of storage and bandwidth. HDTV and HD-DVD require about 4-6 times the bandwidth/storage of STDV and DVD, respectively. Newer standards like H.264 provide much better compression, but there is no existing silicon architecture that can implement it in a cost-effective manner.

Further, market dynamics in adopting video standards require a multi-standard solution. At the moment, MPEG-2 is a mainstream commodity for entertainment applications and MPEG-4 is mainly utilized for mobile or internet applications. The next generation DVD and HD-DVD, is mandated by the DVD-Forum to support three different video formats: H.264, VC-9, and MPEG-2. Japanese broadcasters have adopted H.264 along with MPEG-2 for digital TV broadcast. Future video systems or chips have to support multiple video standards, especially when digital consumer applications are merging with wired and wireless communications.

Also, existing silicon product architectures are not able to fully support newer standards such as H.264 for high-definition applications and do not have the flexibility to support multi-standard processing. It takes multiple chips and software application components to accomplish the required tasks. The cost for currently supporting multi-standard video processing is beyond the reality of a mass market.

Technology gaps exist and current market solutions can not fill. For example, existing compression solutions are mainly based on two product architectures, and become very inefficient in supporting advanced standards such as H.264 or multi-standard processing. These two product architectures can be found in products based on a programmable processor (a general-purposed microprocessor, a media processor, or a DSP) and a hardwired ASIC (Application-specific Integrated Circuit), respectively. The solutions based on a programmable processor, of which a PC is a good example, is very programmable and flexible and runs software compression solutions, but needs a few GHz to process video applications. Although the media processor is optimized for media processing and is flexible like a PC, It is still power hungry and becomes very inefficient for high-definition video processing. The hardwired ASIC is cost effective but very inflexible.

The present invention, which is a hybrid architecture that provides flexibility (similarly to a media processor) and efficiency (similarly to hardwired solutions), overcomes the limitations of the aforementioned product architectures. A key of the present invention lies in how software and hardware processing elements are partitioned, and how underlying platform architecture facilitates such partitioning.

Standards Overview

Another key of the present invention is the ability to process multiple standards for video encode (compression) and decode (decompression) utilizing the platform architecture of the present invention. These standards include H.264 (or MPEG-4 part 10, AVC) and MPEG-4/2, as well as other related video standards.

H.264 was released in 2002 through the ITU-T and ISO/MPEG groups. H.264 has been designed with packet-switched networks in mind and recommend an implementation of a complete network adaptation layer. Due to the joint development of the ITU and ISO bodies, it is also known as MPEG-4 Part 10 or Advanced Video Coding (AVC), to furthermore express these joint efforts. The development goal—to provide at least two times video quality improvement over the MPEG-2 video. To achieve this goal, a H.264-based design can be four to ten times more complex than its MPEG-2 counterpart, depending on target applications.

Standardization bodies in Europe, such as the DVB-Consortium, as well as its American counterpart, the Advanced Television Systems Committee (ATSC), are considering in employing H.264 in their respective standards. H.264 is also widely viewed as a promising standard for wireless video streaming and is expected to largely replace MPEG-4 and H.263+. Given the expected popularity and widespread use of the new H.264 video encoding standard, the design complexity of H.264 video need to be taken into consideration when designing future wired and wireless (e.g., wireless LAN and 3G) networks.

The H.264 standard differs from its predecessors (the ITU-T H.26x video standard family and the MPEG standards MPEG-2 and MPEG-4) in providing important enhancement tools in each step across the entire compression process. The H.264 standard recommends additional processing steps to improve quality of both intra- and inter-frame prediction, texture transform, quantization, and entropy coding.

Prediction is the key to exploit redundancy within a frame (intra-frame prediction) or between frames (inter-frame prediction), and remove the redundancy when the prediction is successfully completed. The more redundancy is removed, the better compression efficiency is. The compression quality is achieved only if the prediction is successfully completed. Typically inter-frame prediction provides better compression than intra-frame prediction because it is used to remove temporal redundancy. Frequently successive frames in a motion video have more unchanged scene or objects, and therefore temporal redundancy is more significant. Inter-frame prediction is also called temporal prediction. On the other hand, the intra-frame prediction is used to find redundancy within a frame and it is also called spatial prediction.

Intra-frame prediction have not been used much in traditional video compression standards, such as MPEG-4, MPEG-2, or H.263. For standards like MPEG-2 and H.263, they simply transform the frame pixel data from the spatial domain to a frequency domain, and filter out high frequency components which is not sensitive to human eyes. MPEG-4 employs AC/DC prediction to exploit spatial redundancy in a limited fashion. H.264/AVC extends this capability by providing additional modes. It provides four intra prediction methods for 16×16 pixel blocks (called Intra-16×16 mode), and nine prediction methods for 4×4 pixel blocks (called Intra-4×4 mode). H.264 recommends that all these methods are performed simultaneously and the one that produce the best result is chosen.

H.264 Inter-frame prediction has been expanded significantly. In addition to motion prediction based on block sizes 16×16, 16×8, and 8×8, it adds prediction methods based on 8×16, 8×4, 4×8, and 4×4. It also allows a tree-structured block that mixes variable block sizes. Given the variable block sized motion prediction, the temporal redundancy can be found in finer details. To further improve prediction accuracy, H.264 allows prediction from multiple reference frames. The prediction methods recommended by traditional standards are based on one past and one future reference frames at most.

Another well-known problem with traditional DCT-based texture transform is the blocking effect accumulated from mismatches between integer and floating-point implementations of the DCT transform, H.264/AVC introduce an integer transform that provides an exact match.

H.264 also recommend better entropy coding schemes. They are context-adaptive variable codes (CAVLC) or context-based arithmetic coding (CABAC). They are proven for generating more efficient code representation than traditional variable-length code (VLC).

Combining all these enhancement tools and other assistant tools, H.264-based compression provides by far the best video quality for any given bit rate requirement. The H.264 standard is the latest innovation in the standards bodies. The MPEG-4 standard has been revised to adopt these innovations within its present specification under MPEG-4 Section 10. Beyond this description, there exist many other standards targeted for different video applications which must be considered. MPEG-2 is the mainstream video standard for consumer applications driven by the demand in DVR, DVD players and set-top boxes (STB). Embedded in many existing commercial applications, the H.263/H.261 and MPEG-4 standards dominate the marketplace. These standards are generally implemented in wireless or wired network applications due to their error resilience structures and excellent bandwidth-to-quality performance capabilities. The newly arrived H.264 standard promises better video quality with one-half of the bit rate compared to the mainstream MPEG-2 solutions. Although H.264 and MPEG-4 are backed by many industry heavy weights and evolving technology alliances, legacy video applications cannot be ignored. Millions of dollars have been spent to make MPEG-2 what it is today. Consumers would be slow to move to a new series of applications due to the financial stake they may have already placed in the MPEG-2 market sector. In respect of this, MPEG-4 and H.264 must peacefully co-exist with MPEG-2 just as MPEG-2 had to live with MPEG-1 and H.263++ and H.263 had to co-exist with H.261.

The MPEG-4 standard, released in February of 1999, has an impressive list of features that covers system, audio, and video. It meant to standardize video, audio, and graphics object coding for adaptive networked system applications, such as, Internet multimedia, animated graphics, digital television, consumer electronics, interpersonal communications, interactive storage, multimedia mailing, networked database services, remote emergency systems, remote video surveillance, wireless multimedia and broadcast applications. These features include a component architecture, support for a wide range of formats and bit rates, synchronization and delivery of streaming data for media objects, interaction with media objects, error resilience and robustness in error prone environments, support for shape and alpha channel coding, a well-founded file structure, texture, image and video scalability, and content-based functionality.

The component architecture calls for content to be described as objects such as still images, video objects and audio objects. A single video sequence can be broken into these respective objects. The still image may be considered a fixed background, the video object may be a talking person without the background and the audio object is the music and/or speech of the person in the video. Breaking the video into separate components enables easier and more efficient coding of the data.

Synchronization and delivery of streaming data for media objects involves transmission of hierarchically encoded data and object content information in one or more elementary streams. Each stream is characterized by a set of descriptors needed by the decoder resources for playback timing and delivery efficiency. Synchronization of elementary streams is achieved through time stamping of individual access units within each stream. The synchronization layer manages the identification of each unit and the time stamping independent of the media type.

Interaction at the user-level is provided as the content composed by the author is delivered, differing levels of freedom may be available which gives the user the ability to interact with a given scene. Operations a user may be allowed to perform include changing the viewing and/or listening point of the scene, dragging objects in the scene to different positions, selecting a desired language when multiple language tracks are available, or triggering a cascade of events through other scene interaction points.

Error resilience assists the access of image, video and audio over a wide range of storage and transmission media including wireless networks. The error robustness tools provide improved performance on error-prone transmission channels (i.e., less than 64 Kbps). These tools reduce the perceived deterioration of the decoded audio and video signals caused by noise or corrupted bits in the transmission stream. Performance and redundancy of the tools can be regulated by providing a set of error correcting/detecting codes with a wide and small-step scalability, a generic and bandwidth-efficient framework for both fixed-length and variable-length frame bit streams and an overall configuration control with low overhead. In addition, classification of each bit stream field may be done so that more error sensitive streams may be protected more strongly.

Support for shape and alpha channel coding includes coding of conventional images and video as well as arbitrarily shaped video objects and the alpha plane. A binary alpha map defines whether or not a pixel belongs to an object. Efficient techniques are provided that allow efficient coding of a binary shape as well as a grayscale alpha plane. Applications that benefit form binary shape maps with images are content based image representations for image databases, interactive games, surveillance and animation. The majority of image coding schemes today deal with three data channels. These include R (Red), G (Green) and B (Blue). The fourth channel, or alpha channel, is generally discarded as noise. However, the alpha channel can define the transparency of an object which is not necessarily uniform. Multilevel alpha maps are frequently used to blend different layers of image sequences. A grayscale map offers the possibility to define the exact transparency of each pixel.

The MPEG-4 file format, a well-founded file structure, is based on the QuickTime® format from Apple Computer, Inc. It is designed to contain the media information in a flexible, extensible format which facilitates interchange, management, editing and presentation of the media independent of any particular delivery protocol. This presentation may be local or via a network or other stream delivery mechanism and is based on components called “atoms” and “tracks.” The file format is composed of object-oriented structures with a unique tag and length that identifies each. These describe a hierarchy of metadata giving information such as index points, durations and pointers to the media data. This media data can even be located outside of the file and be reached through an external reference such as a URL. In addition, the file format is a streamable format, as opposed to a streaming format. That is, the file format does not define an on-the-wire protocol. Instead, metadata in the file provide instructions telling the server application how to deliver the media data over a particular or various delivery protocol(s).

Content-based functionalities provided in the MPEG-4 specification include content-based coding, random access and extended manipulation of content. Content-based coding of images and video allows separate decoding and reconstruction of arbitrarily shaped video objects. In addition, random access of the content in video sequences allows functionalities such as pause, fast forward and fast reverse of stored video objects. Extended manipulation of content in video sequences allows functionality such as warping of synthetic or natural text, textures, image and video overlays on reconstructed video content.

In consideration of the various processes required to take place in the various given standards, existing systems are highly taxed and produce either sporadic or even completely undesirable results. In addition, while being challenged with the ability to commonly produce desired results (i.e., maintaining constant frame rates, high-quality visual output, and network quality-of-service) for a single video and audio standard, it is an unheard of practice to produce these results for multiple standards and making this transparent to the user. Existing systems employ a separate architecture for each standard due to the processing complexities and user interactivity requirements. What is needed is a flexible, adaptable architecture which initially positions itself over the latest video and audio standards but can be modified to fit over future developments, produce consistent, expected results while made easy to configure and operate and takes legacy application requirements into consideration.

Today's challenges in video and audio processing include the needs of emerging applications that require high-definition video processing as well as high-speed networking. The architecture must have a solid hardware foundation and yet have the ability to provide a software-based configurable interface. In this way, software-driven silicon platforms must be co-developed to produce optimum system performance, flexibility and quality-of-service.

This architectural flexibility allows system designers to adopt new technologies, while maintaining backward compatibility with existing solutions. To achieve this goal, the system architecture must be flexible enough to allow system developers the ability to select various application features through software options running on the same silicon device. This flexibility is essential for supporting multi-standard applications which can include video and networking applications.

This design efficiency is achieved by shifting complex, dynamic control functions to processor software and leaving the hardware design with simple, robust, repetitive, data-intensive processing tasks. This approach produces smaller silicon designs that consume less power.

For high-definition video processing, an enormous amount of pixel data is needed to be processed and transmitted in an extremely tight timing budget. For high-speed networking applications, complex decision-making logic and rapidly switching functions drive the performance to levels unreachable by conventional architectures and design approaches. These extreme performance requirements tend to elevate development and material cost. Recently the advancements in the silicon processing technologies and associated manufacturing capabilities have reduced material cost dramatically, but the traditional silicon architectures can not easily satisfy the needs for the emerging applications.

The two most commonly utilized architectures are as follows:

Programmable architectures where this solution is optimized based on a programmable engine, such as a microprocessor, DSP, or media-processor. The major advantage of this approach is its flexibility based on software programmability. The disadvantages are performance uncertainty and power consumption.

The hard-wired architecture solution is mapped to hardware in fixed function logic gates. The advantage using this approach is the predictable performance based on the hard-wired design. This is especially effective for well-defined functions. The major drawback with this approach it its inflexibility for growing features and future product demands. It typically requires another silicon release in order to add features or introduce new functionality.

The architectural solution of the present invention is based on partitioning software functions running in the on-chip processor(s) coupled with hardware accelerated functions optimized for specific tasks. The interaction between processor functions and hardware functions is critical for successful product design. This approach is meant to take advantage of the two approaches mentioned above, but the integration of software and hardware solutions is certainly more involved than a simple integration task.

### SUMMARY OF THE INVENTION

The present invention employs a multi-standard video solution that supports both emerging and legacy video applications. The basic idea is that it implements standard-specific and control-oriented functions in software and generic video processing in hardware. This maximizes the flexibility and adaptability of the system. With this approach, the current invention can support video and audio applications of differing standards and formats without significant hardware overhead. The current invention utilizes a balanced software and hardware partitioning scheme to enable a fluid and configurable solution to the above stated problems. With this platform architecture, various standard applications may be enabled and disabled through a software interface without altering the hardware by replacing hardware gates with software codes for control functions. In this method, the hardware design becomes much simpler and more robust and consumes less power.

The present invention is built based on configurable processors and re-configurable hardware engines. The configurable processors provide an extensible architecture for software development. The re-configurable hardware engines provide performance acceleration and can be re-configured dynamically during run-time.

The hardware platform serves as a delivery vehicle that carries software solutions. Software is the real enabling technology for target system applications. Four key architectural elements which constitute the unique platform includes: a configurable processor, re-configurable hardware engines, a heterogeneous system interconnect, and adaptive resource scheduling.

The present invention takes advantage of strengths from two traditional approaches, i.e., programmable solutions (or software processing) 102 and hard-wired solutions (or hardware processing) 104, while minimizing overhead and inefficiencies. The end result is a balanced software and hardware solution 106 shown in FIG. 1. This balanced software and hardware solution, which is based on configurable processor(s) and re-configurable hardware engines, overcomes the weaknesses associated with software processing 102 (inefficiency in data manipulation and power consumption) and hardware processing 104 (inflexibility for change). The configurable processor(s) allows flexibility in extending instructions, expanding data path design, and configuring the memory subsystem. The hardware engine design of the present invention is quite different from the traditional hard-wired design approach in that they are rule-based and can be re-configured by connected processor(s) at run-time.

By integrating configurable processor(s) and re-configurable hardware engines together, target applications can be either optimized by moving application functions between software and hardware designs until a point of balance is found. The key innovation here encompasses the properties of the designer's definition of extended instruction sets, path design, and other processor design parameters.

Hardware functions are simplified by shifting the majority of the control and redundant tasks to processor software. The remaining hardware functions are converted into re-configurable hardware engines. The hardware engines are simply responsible for data-intensive functions, connectivity and system interfaces. The interaction between processors themselves and the interaction between a processor and hardware engines are crucial for overall system performance. To improve communication channels between the processor and hardware engines, two separate interface buses are used for processing control flows and data flows, respectively.

In one embodiment, a multi-standard video decode system comprises a bitstream “basket” that receives and stores a coded bitstream from external systems, such as a network environment or an external storage space, and at least one configurable processor adapted to receive the coded bitstream and to interpret the received coded bitstream. During the interpretation, the relevant video parameters and data are extracted from the coded bitstream according to a defined, layered, syntax structure. The defined syntax structure differs from standard to standard. Typically the bit stream is coded in a hierarchical fashion, starting from a sequence of pictures, a picture, a slice, a macroblock, to a sub-macroblock. The bitstream decode function performed in processor software extracts the parameters and data at each layer of bitstream construct and passes them to related downstream processes, implemented either in processor software or a hardware acceleration engine. The software and hardware partitioning described in the present invention occurs right at this point of the decode process. At this point, most of standard video decode applications begin to share a set of more generic processing elements, especially for those based on block transform and motion compensated compression.

In another embodiment, a multi-standard video decode system comprises both configurable processors and hardware assistance engines. The key to multi-standard decode support is how the decode functions are partitioned in software and hardware. The standard-specific bitstream decode functions are mainly implemented in software running in one of the processors, A special treatment is needed for accelerating data extraction related to variable-length coding and arithmetic coding. These coding functions are accelerated by adding instructions and co-processor to the base processor.

Well defined, data-intensive, pixel-manipulation functions, such as interpolation and transform are implemented in a rule-based hardware features that can be selected by software according to processing needs of each supported standard. To make the rule-based hardware more effective and robust, the majority of control functions for these hardware engines are implemented in another configurable processor, and an inter-processor communication channel is used to facilitate communications between the bitstream processor and the video decode control processor. To further simplify the hardware design, some of non-timing-critical functions, such as motion vector calculation and DMA (direct memory access) address calculation are performed in the video decode control processor as well.

In a further embodiment, a method for producing a reconstructed macroblock comprises transferring pixel data in and out of a frame buffer located in an external memory device. The DMA (direct memory access) function plays a crucial role in data transfer between the frame buffer and hardware engines. A distributed DMA scheme is used instead of a centralized DMA. For each hardware engine, there is a dedicated DMA function for this purpose. The distributed DMA functions are programmed by the video decode processor to transfer data between their dedicated hardware engines and an external memory device.

In yet a further embodiment, a data traffic coordinator with a capability to allocate memory and bus bandwidth dynamically is used to optimize the data transfer between the hardware engines and an external memory device. The coordinator can perform both dynamic and static scheduling for DMA access to the external memory device.

In yet another embodiment, the multi-standard codec (encode and decode) system comprises all decode system functions described above. The encode-specific functions are forward inter and intra prediction, forward transform, bitstream encode, and rate control. The bitstream encode, rate control, and video encode control functions are implemented in software. The rule-based transform engine for inverse transform can be re-programmed to support forward transform function. The most unique hardware engine for the encode system is the one that performs motion estimation for inter-prediction. The motion estimation engine is designed such that motion search strategy is conducted in software, and pixel manipulation, such as sub-pixel interpolation and sum of absolute differences are performed by hardware,

### BRIEF DESCRIPTION OF THE DRAWINGS

FIG. 1 is a logical state diagram depicting the relationship and balance between selecting correct levels of hardware and software to operate together in accordance with a preferred embodiment of the present invention;

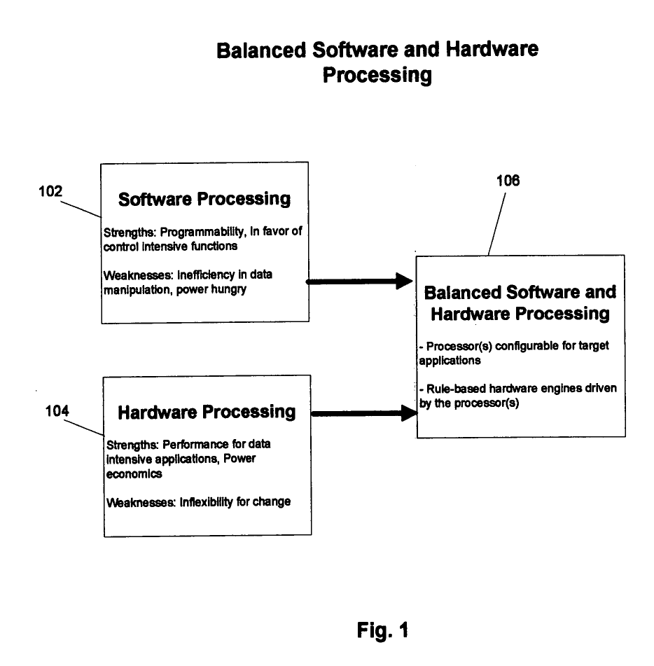

FIG. 2 is a high-level block diagram depicting the separation of control processes and data flows in accordance with a preferred embodiment of the present invention;

FIG. 3 depicts a high-level overview of a sample architecture or platform implementation in accordance with a preferred embodiment of the present invention;

FIG. 4 depicts an architecture or platform implementation with a video decode perspective in accordance with a preferred embodiment of the present invention;

FIG. 5 depicts a block diagram of a multi-standard video decode and encode system in accordance with a preferred embodiment of the present invention;

FIG. 6 is a block diagram of an H.264/AVC decode flow in accordance with a preferred embodiment of the present invention;

FIG. 7 is a block diagram of an MPEG-4 decode flow in accordance with a preferred embodiment of the present invention;

FIG. 8 is a block diagram of an MPEG-2/MPEG-1 decode flow in accordance with a preferred embodiment of the present invention;

FIG. 9 is a block diagram of an H.264/AVC encode flow in accordance with a preferred embodiment of the present invention;

FIG. 10 is a block diagram of an MPEG-4 encode flow in accordance with a preferred embodiment of the present invention; and

FIG. 11 is a block diagram of an MPEG-2/MPEG-1 encode flow in accordance with a preferred embodiment of the present invention.

### DETAILED DESCRIPTION OF THE INVENTION

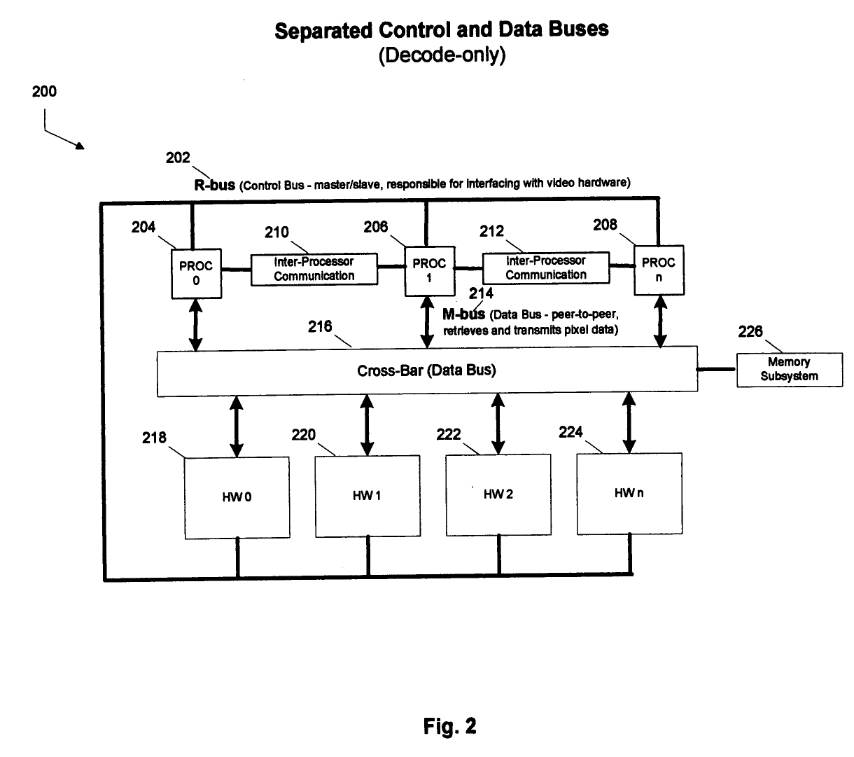

Referring now to FIG. 2, the system 200 of the present invention includes a plurality of busses such as the R-bus 202, the M-bus 214, and the cross-bar or data bus 216, processors 204-208, Inter-processor communication buses (IPC) 210-212, hardware engines 218-224, and a memory subsystem 226. The processors 204-208 use the R-bus 202 to interact with video hardware engines for control flow processing and the M-bus 214 for data flow processing. The R-bus 202 is a master-slave bus, while the M-bus 214 is a peer-to-peer bus connected to the system cross-bar network 216 (system interconnect as described below) to access system resources. The IPC bus 210-212 (or third bus) handles message data passing between processors. In summary, there are three major buses to facilitate all control and data flow processing. They are the IPC bus for inter-processor communications in a distributed multi-processor environment, the R-bus 202 for interaction between a processor 204-208 and hardware engines 218-224, and the M-bus cross-bar 214 mainly for heavy data traffic between hardware engines 218-224 and the memory subsystem 226.

Connecting processor(s) with system modules that may come from a variety of sources, the so-called heterogeneous system interconnect is needed to pass or route data and control streams. The control and data flows are coordinated by a scheduler that adopts a hybrid scheme using both dynamic and static scheduling techniques. Archiving adaptive bandwidth allocation provides the ability to monitor the internal resource usage pattern and to dynamically allocate system bandwidth as needed, while maintaining isochronous channels if necessary. The concept of adaptive bandwidth allocation is discussed more fully in U.S. Patent Application Docket No. VisionFlow.00002, entitled ADAPTIVE BANDWIDTH ALLOCATION OVER A HETEROGENEOUS SYSTEM INTERCONNECT DELIVERING TRUE BANDWIDTH-ON-DEMAND, filed on even date herewith.

The system interconnect of the present invention ties together processors, special hardware functions, system resources, and a variety of system connectivity functions. Each of these processing elements including processors can be added, removed, or modified to suit specific application needs. This interconnect mechanism facilitates a totally modular design environment, where individual processing elements can be developed independently and integrated incrementally.

Given the platform architecture of the present invention, system bottlenecks can be identified and measured by profiling target applications more readily. Profiling the system guides software and hardware design partitions that lead to an optimized and well-executed architectural product design.

The process of ensuring the most optimized product design of the present invention involves: (1) profiling the target applications with the baseline configurable processor(s), (2) identifying the performance bottlenecks based on the gathered profiling data, (3) extending and modify the instruction sets and data path design to remove or minimize the bottlenecks, (4) identifying the bottlenecks which cannot be removed by configuring the processor architecture, and design assisted hardware to remove the bottlenecks, (5) fine tune hardware engine and system interconnect design until all the bottlenecks are removed, (6) designing rule-based and parameter-driven hardware engines that can be shared by multiple applications, and (8) repeating the stated optimization steps until the performance-cost requirement has been met.

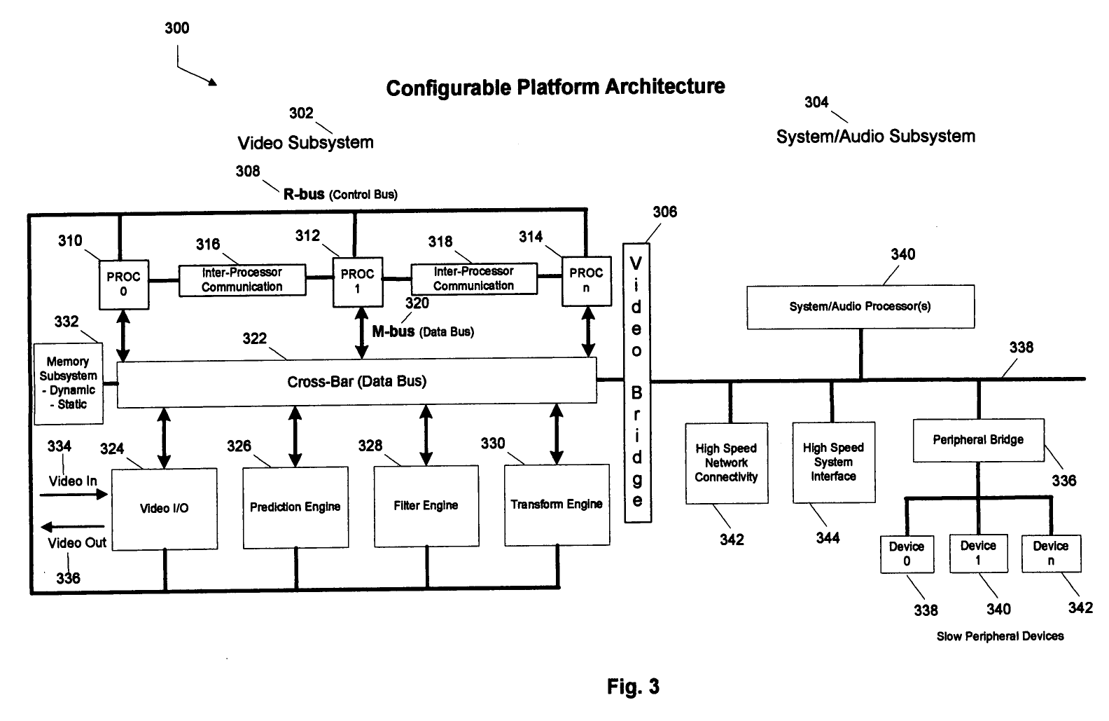

An example of the stated architectural implementation is demonstrated as system 300 in FIG. 3 which includes a video subsystem 302 and an audio subsystem 304. The video subsystem 302, which is the focus of the present invention, is separated from the audio subsystem 304 by the video bridge 306 which permits data to be sent between the audio subsystem and the video subsystem. The video subsystem 302 is similar to the system 200 of FIG. 2 with additional detail surrounding the hardware engines such as a video I/O 324 (which receives video 334 and transmits video 336, a prediction engine 326, a filter engine 328, and a transform engine 330. The audio subsystem 304 includes, among other elements, system/audio processor(s) 340, a high speed network connectivity module 342, a high speed system interface 344, a peripheral bridge 336 and slow peripheral devices 338-342 connected to one another and to the video bridge via bus 338.

The system 300 can be used as a networked media platform for applications that require both media processing and networking. Based on the architectural concept of the present invention, the figure illustrates how processor(s), various system interfaces, audio, and video processing components are connected and interact together. In this example, system control, networking, media control, audio compression/decompression (audio codec), and video codec control have been implemented in processor software. Video pipeline provides acceleration for essential pixel processing common to most standard video compression. Well-defined system and network interfaces are implemented in hardware.

The choices that exist for the processor architecture are a uni-processor or a multi-processor. The type of processor combination is chosen based on the target application. The uni-processor architecture is usually used for power-sensitive, cost-effective applications and the multi-processor is targeted for applications demanding performance. The system 300 can be implemented in a dual-processor architecture by dedicating video processing in one configurable processor and the system and audio functions in the other. The inter-processor communications can be performed through simple mail-box handshakes instead of a more complex shared memory model. In this case, bursty memory interfaces and effective bus interconnects are critical in achieving the desired performance levels due to the frame buffers being stored in external DRAM devices. Without high-throughput frame buffer accessibility, for example, video-related processing tasks would likely stall.

This higher-level partition between the software and hardware processes is the key to producing the desired results for decoding multiple standard video and audio bit streams. Several components are required for this partition to work effectively. Three of the major components include the processor architecture, a cross-bar interconnect, and re-configurable hardware accelerators. With the addition of these specific components, the given platform architecture enables a very effective software/hardware partitioning.

The processor architecture regulates the software performance but providing capabilities bound to the specific functions needed within the bitstream decoding process. The platform solution is flexible in that it allows uni-processors and multi-processors, configurable (extensible) processors and fixed-instruction processors and any combination of these. Each of these processors has the ability to communicate with each other through an inter-processor interface protocol 316-318.

The cross-bar interconnect 322 is a non-blocking, high-throughput, heterogeneous apparatus with the capability to communicate with a variety of system components from differing sources. This cross-bar interconnection scheme allows independent data and control flows to be processed simultaneously and forms a bridge to allow the data to be directed to the appropriate decoding component block.

The re-configurable hardware accelerators are designed to enable the generic engine activities of the system. These can be dynamically configured during run-time to support the many needs of the independent standard processes.

To apply the current invention to a video decode (decompression) application, a set of processes that constitute the decode process flow are used to illustrate multi-standard decode capability. There are four generic processes for video decode applications: (1) entropy decode, (2) inverse prediction, (3) inverse transform, and (4) reconstruction/filter. H.264 video decode fully utilize this four processes to achieve the best performance. Others like MPEG-4 and MPEG-2 simply use partial of these processes. During the entropy decode process, the video bitstream is analyzed and essential control and data (video decode parameters) for reconstructing a video frame are extracted. The output from this process consists of different sets of video processing parameters required for the downstream processes: inverse prediction, inverse transform, and reconstruction/filter.

The inverse prediction process receives motion vector information from the entropy decode process if the frame is inter predicted, and reference pixel information if the frame is intra predicted. Almost all standard video perform inter prediction. MPEG-4 video performs partial intra prediction called AC/DC prediction and MPEG-2 does not perform any. The coded prediction errors (called coded residuals) are passed from the entropy decode process to the inverse transform process that include inverse scan and inverse quantization to obtain actual residuals. The residuals are used in the reconstruction/filter process to reconstruct a picture on a microblock by microblock basis. The filter operation is optional for most standard video except for H.264. H.264 standard includes an in-loop deblocking filter to remove blocking artifacts. The filter interpolates the overlapped regions of the reconstructed macroblocks so that they resulting video quality has been improved.

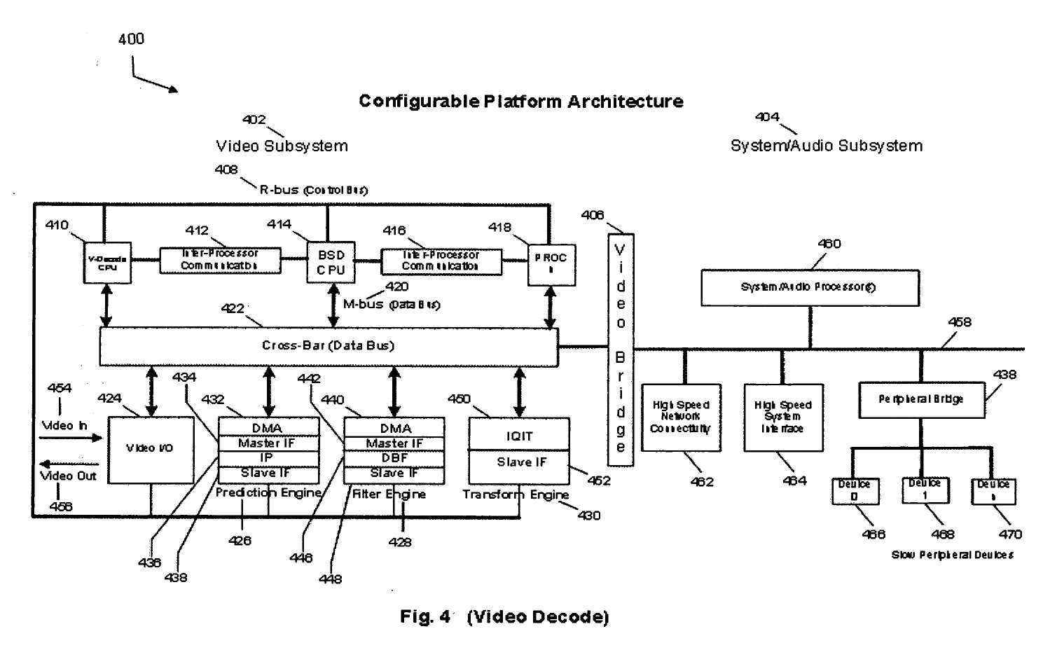

Referring now to FIG. 4, a system 400 implementing a multi-standard decode in a multi-processor environment by dedicating video processing in two configurable processors and the system and audio functions in the other processor is depicted. The video subsystem 402 is similar to the video subsystem 302 of FIG. 3 with additional detail surrounding the hardware engines such as the prediction engine 426 (which includes a direct memory access (DMA) block 432, a master IF block 434, an inverse prediction block (IP) 438, and a slave IF block 438), the filter engine 428 (which includes a DMA block 440, a master IF block 442, a deblocking filter (DBF) block 446 (which is utilized for H.264 related applications), and a slave IF block 448), and a transform engine 430 (which includes an inverse quantization/inverse transform (IQIT) block 450 and a slave IF block 452). Although depicted in a certain position, the modules of the system 400, such as the prediction engine, the filter engine, and the transform engine, may be arranged in a variety of positions. Further, direct communication between the modules of the system 400, such as the prediction engine, the filter engine, and the transform engine, is supported.

In the system 400, the synchronization between the audio and video processing is performed in the system/audio processor 460 (or in a separate system processor and audio processor). Control communication between the system/audio processor and video processors is through the IPC similar to 412-416, and data communication is through a video bridge 406. The video bridge 406 is responsible for data transfer between two buses: one which is associated with the system/audio processor (which is implemented in a traditional shared bus fashion), and one which is associated with the video processors (which is implemented in a cross-bar fashion). The video bridge 406 decouples heavy data traffic of video processing domain from relatively light data traffic of system/audio processing domain.

Of course, real-world applications are not constrained to this configuration. However, in this example, the platform is split into two processing domains. The video processing domain, is responsible for video decode functions. It has five major functional blocks: two video processors (control 410 and bitstream decode (BSD) 414, and three hardware engines IQIT 450, IP 436, and DBF 446. The bit-stream decoder CPU 414 decodes the video bit stream de-multiplexed by the system/audio CPU 460 in the other domain. The decoded video bits are sent to the IQIT engine 450 for inverse quantization and inverse transform in order to generate the image residual result.

Meanwhile, the video control CPU 410 calculates the motion vectors for the reference images and configures the inverse prediction block to fetch the reference image and interpolate the data, if the prediction is performed in a inter-frame prediction fashion when the image is encoded. If the prediction is performed in an intra-frame fashion, the predicted image is interpolated in the same way as it was interpolated during the encode process. When the residual result is generated and the predicted image is interpolated, the IP reconstructs the decoded image and sends it to the DBF (in the case of H.264) for optional filtering of the edges in the image planes. The final data is stored in the external DDR (double data rate) memory for further image reference as well as transmitting. The DDR is mainly used for video processing. Another external SDR (single date rate) memory in the other domain is used for system/audio processing.

The video-decode CPU 410 plays a critical role in the decoding flow. It not only calculates the motion vectors of the reference images and the image location of referenced/reconstructed images, but also schedules the data flow through BSD, IQIT, IP and DBF modules.

The BSD CPU 414 is a small but dedicated CPU which performs the bit parsing of the video data. Once the data elements have been parsed, they are transmitted to the IQIT. It performs bit parsing according to a bitstream syntax defined by different standards. The parsing tasks, which differ from standard to standard, are essential for multi-standard support.

The data processing which occurs in the IQIT, IP and DBF are macroblock-oriented. In other words, each of these modules holds a given amount of pixel data to process. The results of the macroblock-based processing are transmitted from one stage to the next stage until the decode processing of this macroblock is completed. The macroblock image processing flows in a domino-fashion through these stages. When data is completed at the current stage and the next stage hardware is available, the video control CPU 410 can immediately issue the kick-start to that particular the next stage hardware. The domino effect is enhanced when a private data channel is used between IQIT and another channel between IP and DBF. With the private channels, data can be passed directly from IQIT to IP and from IP to DBF, without being routed through the busy M-bus cross-bar.

The video decode processing demands a very high data bandwidth, especially for high-definition image compression. A cross-bar 422 has a built-in arbitration scheme to handle data contention by giving each video module a fair share to access the shared memory subsystem. The built-in scheme can be programmed to handle more complex arbitration logic as well. The video pipeline is self-adaptive to the data bandwidth as well, given the domino nature of the processing flow. For example, consider the case that the IP and DBF fight for an access to the external memory. The IP wants to fetch reference frames for analyzing the current macroblock, while the DBF wants to write back the previous reconstructed macroblock. Assume that the DBF gets access first. Once the DBF finishes writing back one macroblock and does not have a macroblock ready for writing back, it give the access to others. So, by utilizing the domino fashion in the data flow, the proper bus access is guaranteed without deadlock and the fairness in the arbitration is self-adaptive.

Since the video decode processing is very demanding in memory bandwidth, the video processing domain has its dedicated memory subsystem, separated from the memory subsystem for system/audio processing.

The system/audio processor(s) 460 is mainly responsible for system control, video/audio synchronization, audio processing, and video bitstream detection (for selecting a proper BSD in the other domain). More specifically, it performs the user interface, network interface, transport decode, audio/video stream de-multiplexing, as well as less bandwidth demanding audio decode.

System Overview—Multi-Standard Video Decode and Encode System

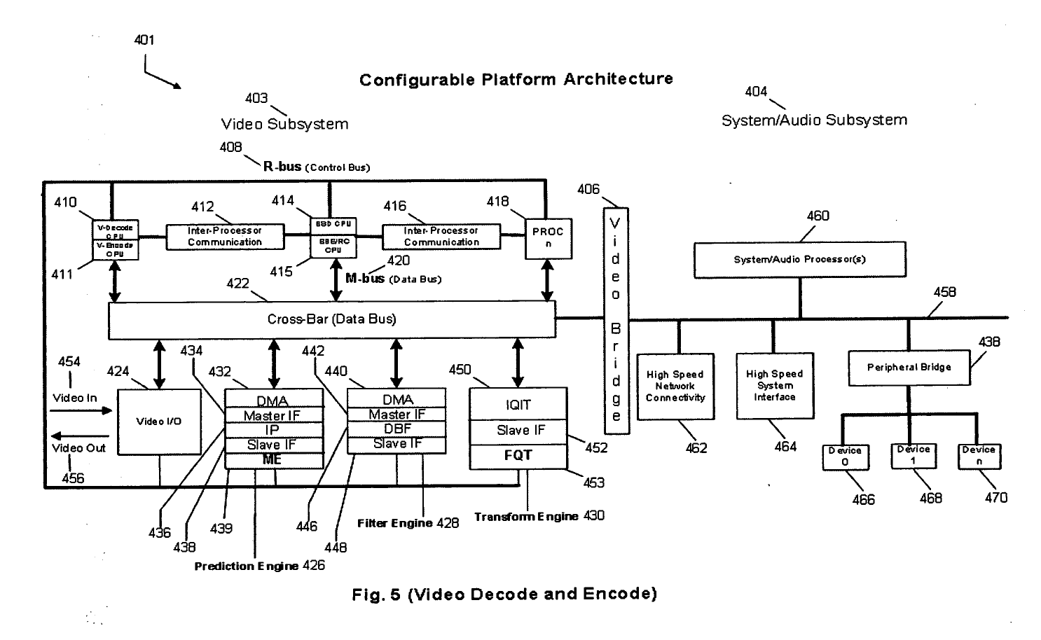

Referring now to FIG. 5, a system 401 implementing a multi-standard codec (encode and decode) application is depicted. The video subsystem 403 is similar to the video subsystem 402 of FIG. 4 which illustrates the scalability of the platform architecture of the present invention. By adding an additional processor for video encode control (V-Encode CPU 411) and an additional hardware engine for forward motion prediction or estimation (ME 439), the decode design (described in FIG. 4) is converted into the encode and decode (codec) design of FIG. 5. A minor enhancement of the IQIT engine in the decode design converts the IQIT engine into a processing engine that handles both inverse and forward quantization and transform (FQT) 453. The enhancement is performed by re-programming microcode embedded within the original IQIT engine and adding a small forward quantization unit. Also, a bit stream encode/rate control (BSE/RC) CPU 415 is added to provide bit stream encode and rate control functionality. Although depicted in a certain position, the modules of the system 500, such as the prediction engine, the filter engine, and the transform engine, may be arranged in a variety of positions. Further, direct communication between the modules of the system 500, such as the prediction engine, the filter engine, and the transform engine, is supported.

Since an encode design requires built-in decode functions, the decode functions previously described can be re-used for this purpose. The decode functions are used for reconstructing an encoded image in the same way as a decode design is expected to do. The reconstructed image (also called predicted image) is compared against the actual image before the encode process. The difference (also called prediction error or residual) is then coded and becomes a part of bitstream to be sent to a decoder.

Major encode functions can be divided into four stages: (1) prediction, (2) transform/quantization, (3) reconstruction/filter, and (4) entropy coding. During the prediction stage, encoder performs both inter-frame and intra-frame prediction (439) and the best result is sent to the second stage: transform/quantization (453). After the second stage, the quantized image is then reconstructed through an inverse quantization/transform (IQIT 450) at the third stage for calculating residual (prediction error). An optional deblocking filter 446 can be applied if chosen (in the case of H.264) at the third stage. At the final stage, the predicted results (motion vectors, inter/intra prediction reference information) along with prediction errors (residuals) are entropy coded with a bitstream syntax defined by a chosen standard.

Among all encode processing functions, inter-frame prediction that involves motion estimation is the most computation intensive. Depending on the size of chosen motion search window and sub-pixel accuracy, the demand of processing and memory bandwidth can be several hundred times what is needed for all decode functions combined. To lower the computation requirement to a realistic level such that the motion estimation can be implemented, motion search algorithm is the key. Many search algorithms have been proposed to solve this problem, but they all have strengths and weaknesses. The best result normally requires a mix of different algorithms under different circumstances.

To design an optimum process that handles a mix of various motion algorithms, the design has to take advantage of flexibility from a software implementation and performance offered by a hardware implementation. As such, the software and hardware partition of the present invention becomes essential to achieve this goal.

According to the principle of the current invention, the motion estimation design has been divided into software and hardware functions in the following manner. Hardware design is responsible for pixel comparison between the current image and reference images, which is the most execution intensive and memory bandwidth consuming, and sub-pixel interpolation, which is explicitly defined in each standard. Software design takes all remaining tasks, such as search strategy (algorithm dependent), block-size determination, and rate-distortion optimization.

The H.264 standard recommends the variable block sized motion estimation. Instead of performing the traditional 16×16 or 8×8 motion estimation, the standard provides the options for motion estimation based on the following block sizes: 16×16, 16×8, 8×16, 8×8, 8×4, 4×8, and 4×4. The software and hardware partition in the current invention allows different combinations of the recommended sizes to be exploited and find the one that provides the best tradeoff between performance and cost.

The present invention describes software and hardware partitioning for multi-standard video compression and decompression. The software functions are implemented in the on-chip processors, and the hardware functions implemented in hardware engines. The three buses facilitate effective communications between software and hardware are (1) IPC for inter-processor (CPU) communications, (2) R-bus for control communications between processors and hardware engines, and (3) M-bus cross-bar for heavy data transfer between memory subsystem and hardware engines (and also service occasional data transfer between a processor and the memory subsystem).

System Overview—Multi-Standard Video Decode Flows

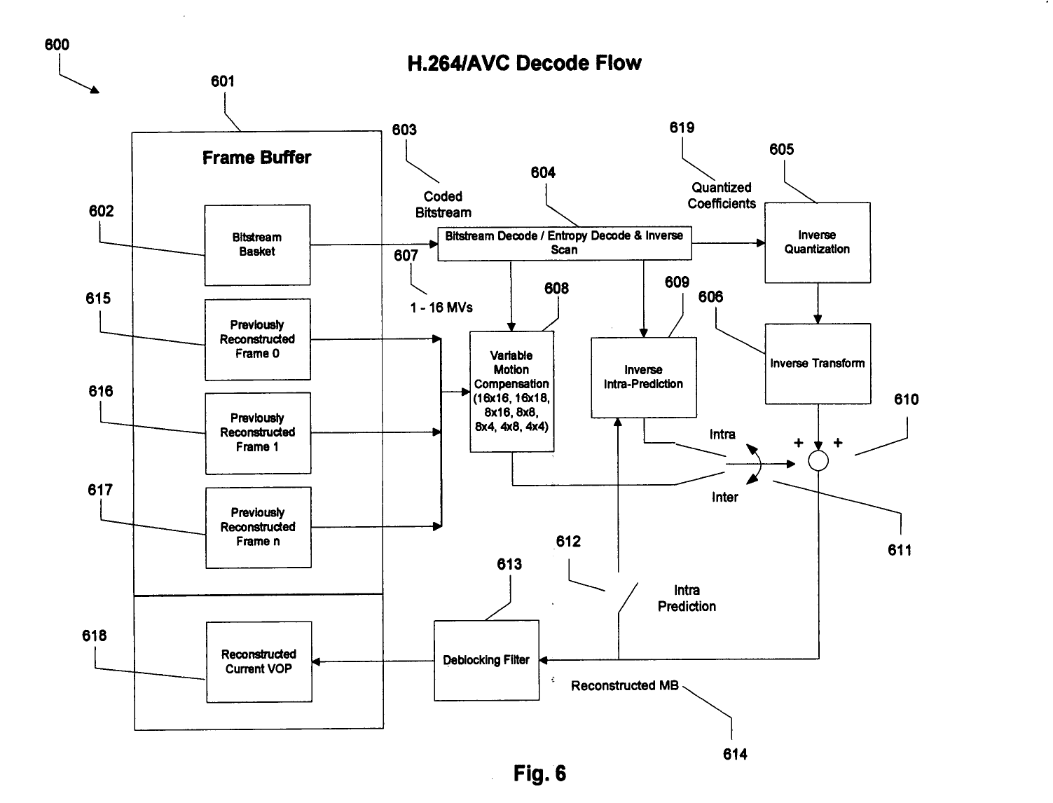

Referring now to FIG. 6, an H.264/AVC decode flow 600 of the present invention is depicted. An input signal (a coded bitstream in this case) is loaded into a bitstream basket 602 inside a frame buffer 601 and transmitted to a bitstream decoder 604. The bitstream decoder 604 entropy decodes the coded bitstream 603, inverse scans the coded bitstream 603 and acts as a logical multiplexer which generates up to 16 motion vectors 607, a set of quantized coefficients 619, or an intra prediction mode indicator.

Once a set of quantized coefficients 619 is produced, it is transmitted by the bitstream decoder 604 to the inverse quantization module 605. The inverse quantization module performs the reverse quantization on the transmitted coefficients and generates de-quantized coefficients which are transmitted by the inverse quantization module 605 to an inverse transform module 606. The de-quantized coefficients are acted upon by the inverse transform and become a set of residual values (prediction errors) that will be added with predicted macroblock pixels in the adder block 610 when they are available.

Once the motion vectors 607 are generated by the bitstream decoder 604, they are transmitted to a variable sized motion compensation block 608. The variable sized motion compensation block 608 fetches referenced macroblocks from a previously reconstructed frame (615, 616, and/or 617) based on these motion vectors. This variable motion compensation block 608 produces an inter-predicted macroblock which is transmitted to the adder block 610 for reconstruction along with the residual values mentioned above.

If the bitstream decoder 604 detects an intra-predicted macroblock, the bitsream decoder transmits the chosen intra prediction mode to the inverse intra-prediction module 609. The inverse intra-prediction is applied to reproduce intra-predicted macroblock. Similar to the inter-predicted macroblock, the related residual values recovered from the inverse transform will be added to the intra-predicted macroblock for reconstruction.

Once the macroblock is reconstructed, a portion of the macroblock pixels can be passed to the inverse intra prediction module 609 for future prediction use, and/or passed to the deblocking filter module 613 for a filter operation. Finally the filtered, reconstructed macroblock is written back to the current reconstructed frame 618 and is ready for display.

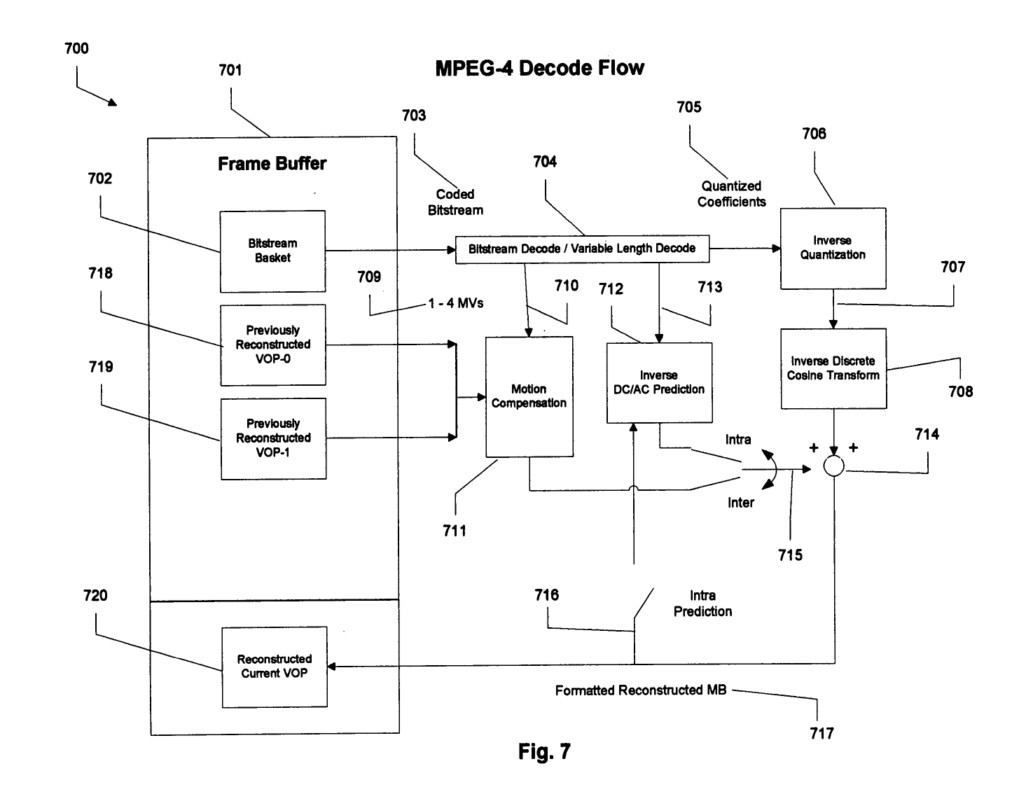

Referring to FIG. 7, an MPEG-4 decode flow 700 of the present invention is depicted. An input signal, which may include a coded bitstream 702, a first previously reconstructed video object plane (VOP, as described within the MPEG-4 specification) 718, another previously reconstructed VOP 719, or a last previously reconstructed VOP (or other input signal), is held in a frame buffer 701. Once the frame buffer 701 has received the input signal, a coded bitsream 703 is transmitted to a bitstream decoder 704. The bitstream decoder 704 entropy decodes a coded bitstream 703 based on a variable-length decoder, inverse scans a coded bitstream and acts as a logical multiplexer which generates up to 4 motion vectors 709, a set of quantized coefficients 705, or an AC/DC prediction indicator 713.

Once the quantized coefficients 705 are produced, they are transmitted by the bitstream decoder 704 to the inverse quantization module 706 which performs the reverse quantization on the transmitted coefficients and generates de-quantized coefficients which are transmitted by the inverse quantization module 706 to an inverse discrete cosine transform module 708. The de-quantized coefficients are acted upon by the inverse transform and become a set of residual values (prediction errors) that will be added with predicted macroblock pixels in the adder block 714 when they are available.

Once the motion vectors 709 are generated by the bitstream decoder 704, they are transmitted to a variable sized motion compensation block 711. The variable sized motion compensation block 711 fetches referenced macroblocks from a previously reconstructed frame based on these motion vectors. This variable motion compensation block 711 produces an inter-predicted macroblock which is transmitted to the adder block 714 for reconstruction along with the residual values mentioned above.

If the bitstream decoder 704 detects an intra-predicted macroblock, the bitsream decoder transmits the chosen intra prediction mode to the inverse DC/AC prediction module 712. The inverse DC/AC prediction is applied to reproduce an intra-predicted macroblock. The related residual values recovered from the inverse transform will be added to the intra-predicted macroblock for reconstruction.

Once the macroblock is reconstructed, a portion of the macroblock pixels can be passed to the inverse DC/AC prediction module 712 for future prediction use. Finally, the reconstructed macroblock is written back to the current reconstructed frame 720 and is ready for display.

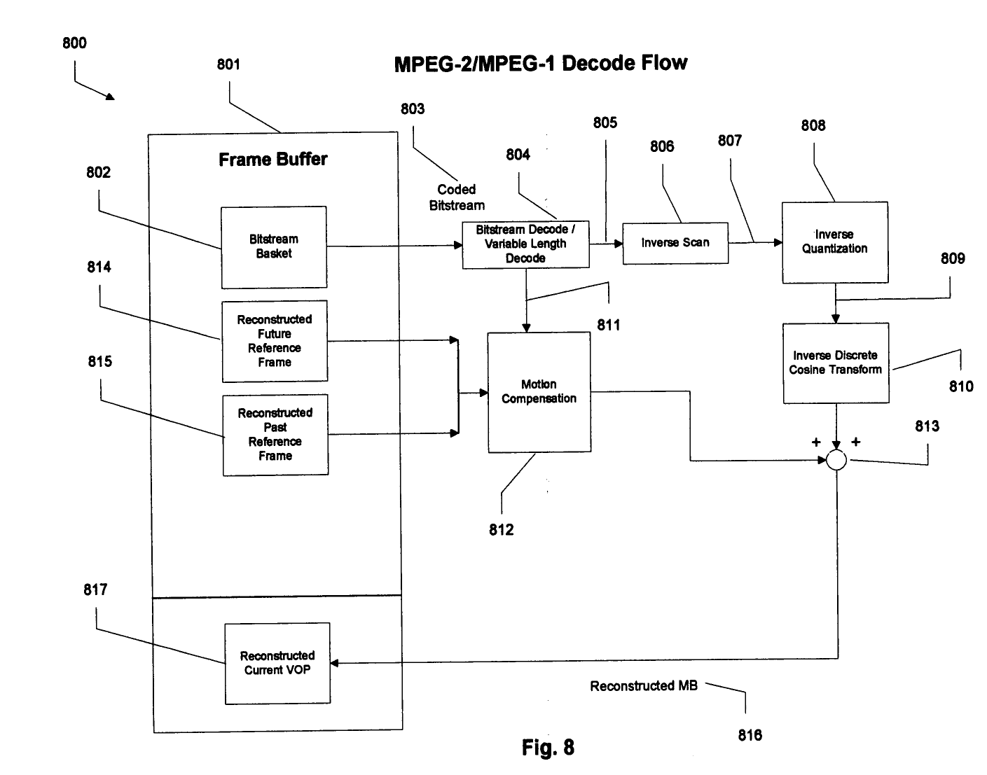

Referring now to FIG. 8, an MPEG-2/MPEG-1 decoder 800 of the present invention is depicted. A coded bitstream is held in a bitstream basket 802 of a frame buffer interface 801. Such input signals may include a first previously reconstructed future frame 814, or a previously reconstructed past frame 815. Once the frame buffer interface 801 has received an input signal, a coded bitstream 803 is transmitted to a bitstream decode and variable length decode module 804. This bitstream decoder 804 entropy decodes the coded bitstream 803 based on a variable-length decoder and transmits the scanned, quantized coefficients 805 to either an inverse scan module 806, or motion vector(s) 811 to a motion compensation module 812.

When the inverse scan module 806 receives scanned coefficients 805, it inversely scans them to generate a group of quantized coefficients 807. These coefficients are transmitted to an inverse quantization module 808 which produces de-quantized coefficients 809. The inverse quantization module transmits the coefficients 809 to an inverse DCT module 810.

Once the inverse discrete cosine transform block 810 receives the coefficients 809, the module transforms the coefficients into a set of pixel values that can be intra macroblock pixels or residual values for motion compensation. When the motion compensation block 812 receives a motion vector 811, the block fetches predicted macroblock(s) from the frame buffer 801 based on the motion vector. The macroblock can come from either a future reference frame 814 or a past reference frame 815. The predicted macroblock is added with the residual pixels to form the reconstructed macroblock.

System Overview—Multi-Standard Video Encode Flows

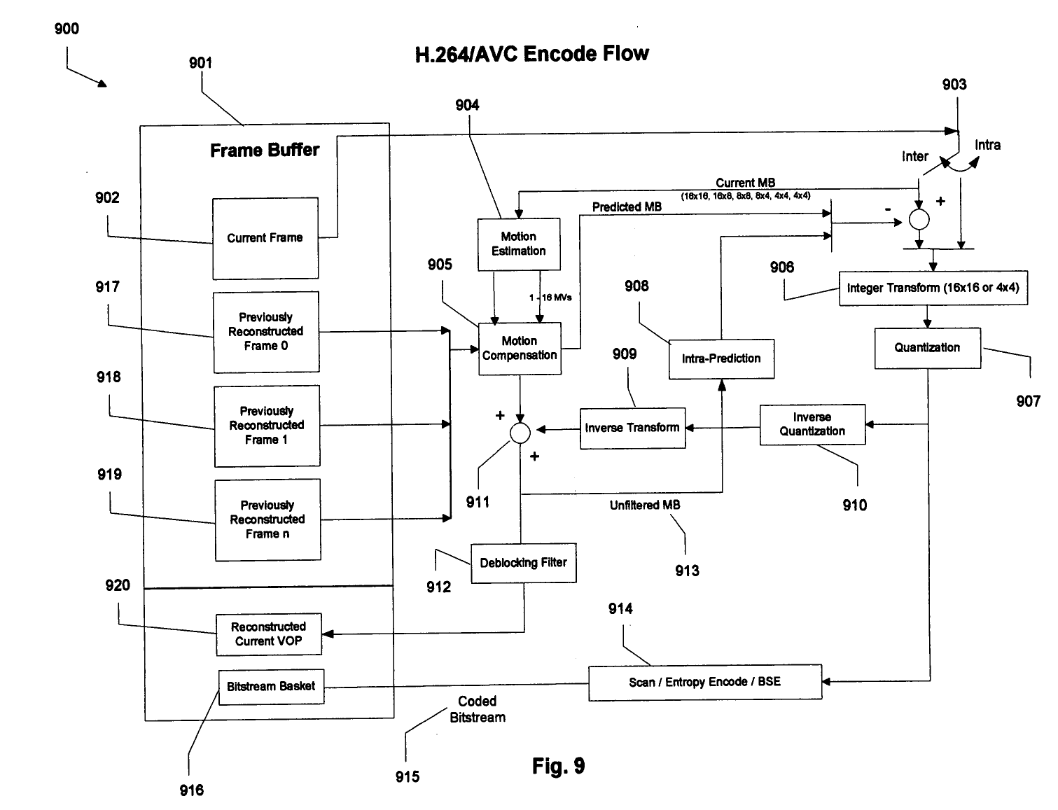

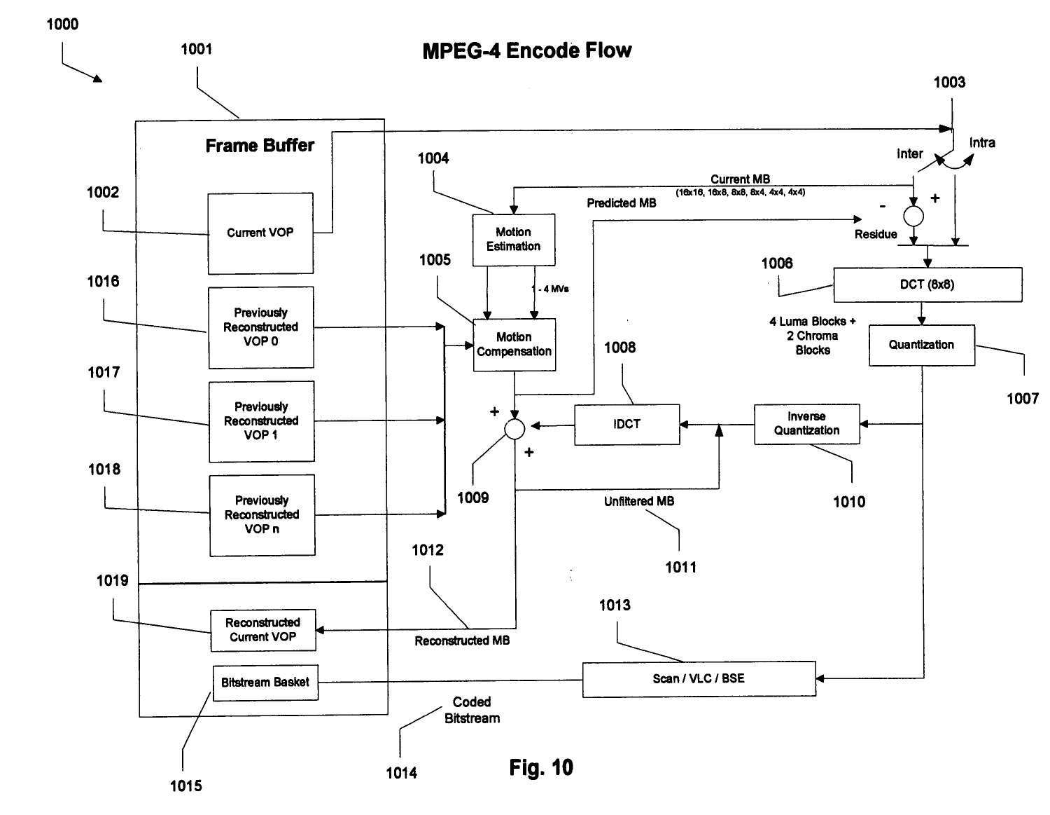

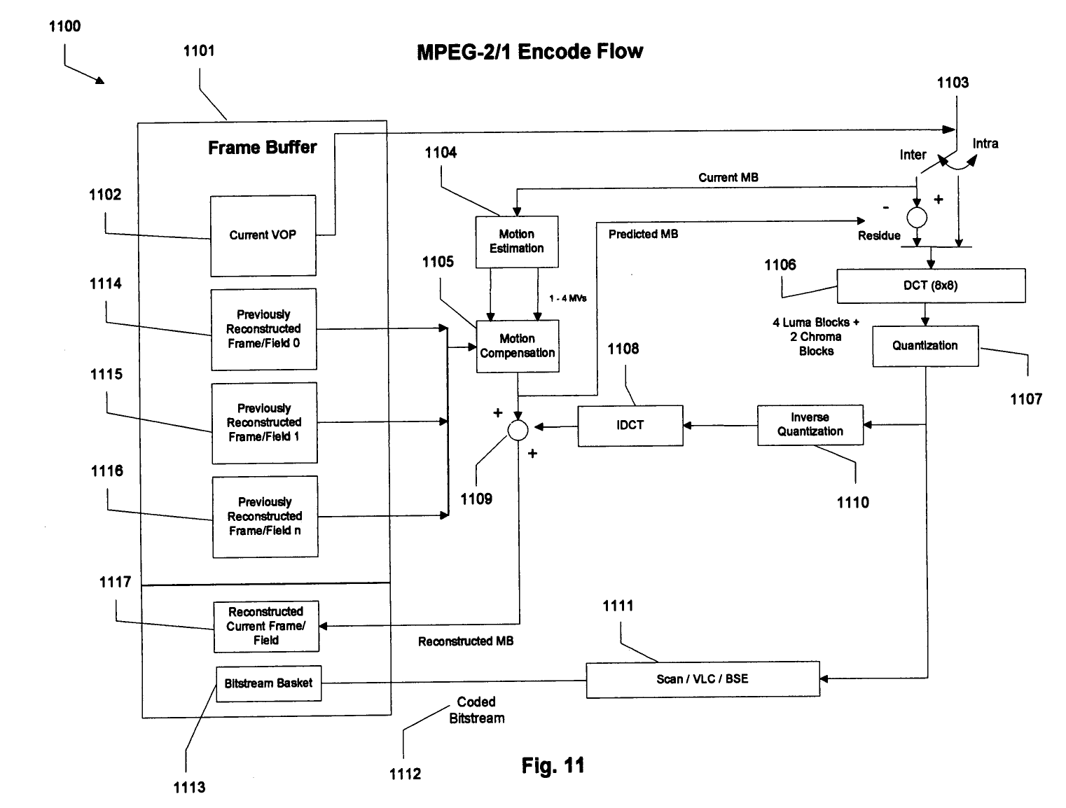

Regarding FIGS. 9-11, the systems 900, 1000, and 1100 describe the H.264/AVC, MPEG-4 and MPEG-2/1 encoder process flows, respectively. The basic encode flow can be broken down into the following steps: (1) Frame Capture (902, 1002, 1102) which captures the input frames and prepares them for the encode process, (2) Coding Decision (903, 1003, 1103) which decides if the frame should be intra or inter frame/field/VOP encoded, (3) manage the Intra Coding or Spatial Prediction (906, 1006, 1106)—intra prediction is exclusive to H.264 while MPEG-4 uses prediction based on coefficients resulting from the spatial transform (AC/DC), (4) manage the Inter Coding or Temporal Prediction (904, 905, 1004, 1005, 1104, 1105) which is based on an in-loop decision process initiated after the prediction is computed to gather the prediction residuals, (5) Texture Processing (907 and 912, 1007, 1107)—H.264 utilizes an integer-based, reversible transform whereas a floating-point DCT is used for MPEG. Quantization steps are adjusted by the Rate Control to keep a bit rate budget (applications can choose from CBR (Constant Bit Rate) or VBR (Variable Bit Rate)), (6) and Bitstream Encoding (914, 1013, 1111) which includes the scan and entropy coding processes.

Although an exemplary embodiment of the system and method of the present invention has been illustrated in the accompanied drawings and described in the foregoing detailed description, it will be understood that the invention is not limited to the embodiments disclosed, but is capable of numerous rearrangements, modifications, and substitutions without departing from the spirit of the invention as set forth and defined by the following claims.

1. A multi-standard video encode and decode system, comprising:
busses;
video hardware engines;
processors adapted to utilize a first of the busses to interact with the video hardware engines for control flow processing, a second of the busses for data flow processing, and a third of the busses for inter-processor communications; and
a system data bus adapted to permit data exchange between system resources, the busses, the engines, and the processors.

2. The multi-standard video encode and decode system of claim 1 comprising a memory subsystem adapted to exchange heavy data traffic with the video hardware engines.

3. The multi-standard video encode and decode system of claim 2 wherein the memory system and the video hardware engine are operably coupled via the second of the busses.

4. The multi-standard video encode and decode system of claim 1, wherein the first of the busses is a master-slave bus.

5. The multi-standard video encode and decode system of claim 1, wherein the second of the busses is a peer-to-peer bus.

6. The multi-standard video encode and decode system of claim 1, wherein the third of the busses is an inter-processor communications bus.

7. A multi-standard video encode and decode system, comprising:
a video subsystem, comprising:
busses;
video hardware engines;
video processors adapted to utilize a first of the busses to interact with the video hardware engines for control flow processing, a second of the busses for data flow processing, and a third of the busses for inter-processor communications; and
a system data bus adapted to permit data exchange between system resources, the busses, the engines, and the processors;
an audio subsystem; and
a video bridge operably coupled to the video subsystem and the audio subsystem.

8. The multi-standard video encode and decode system of claim 7, wherein the video hardware engines are at least one of:
a prediction engine;
a filter engine; and
a transform engine.

9. The multi-standard video encode and decode system of claim 8, wherein the prediction engine includes at least one of:
a direct memory access block;
a master bus interface block;
an inverse prediction block;
a forward prediction block; and
a slave bus interface block.

10. The multi-standard video decode system of claim 8, wherein the filter engine includes at least one of:
a direct memory access block;
a master bus interface block;
a deblocking filter block; and
a slave bus interface block.

11. The multi-standard video encode and decode system of claim 9, wherein the transform engine includes at least one of:
an inverse quantization/inverse transform block;
a forward quantization/forward transform block; and
a slave bus interface block.

12. The multi-standard video encode and decode system of claim 7 further comprising a bus in the audio subsystem coupled to the system data bus via the video bridge.

13. The multi-standard video encode and decode system of claim 12 further comprising a system/audio processor, coupled to the audio subsystem bus, adapted to synchronize between audio processing and video processing.

14. The multi-standard video encode and decode system of claim 13, wherein control communication between the system/audio processor and the video processors is via the third or the second of the busses.

15. The multi-standard video decode system of claim 13, wherein data communication between the system/audio processor and the video processors is via the video bridge.

16. The multi-standard video decode system of claim 11, wherein the video processors are at least one of:
a bit-stream decoder processor adapted to decode video bit stream de-multiplexed by the system/audio processor; and
a video decode processor adapted to calculate motion vectors for reference images.

17. The multi-standard video decode system of claim 16, wherein the bit-stream decoder processor configures the inverse prediction block to fetch the reference image and interpolate sub-pixel data, if an inter-frame prediction is performed when an image is encoded.

18. The multi-standard video decode system of claim 16, wherein the predicted image is intra-interpolated, if an intra-frame prediction is performed when an image is encoded.

19. The multi-standard video decode system of claim 16, wherein the video decode processor schedules data flow through at least one of:
the bit-stream decoder;
the inverse quantization/inverse transform block;
the inverse prediction block; and
a deblocking filter block.

20. The multi-standard video decode system of claim 19, wherein data processing which occurs in the inverse quantization/inverse transform block, the inverse prediction block, and the deblocking filter block are macroblock-oriented.

21. A multi-standard video decode and encode system, comprising:
a master-slave bus, a peer-to-peer bus, and an inter-processor communications bus;
a prediction engine, a filter engine, and a transform engine; and
a video encode control processor, and a video decode control processor adapted to utilize the master-slave bus to interact with the video hardware engines for control flow processing, the peer-to-peer bus for data flow processing, and the inter-processor communications bus for inter-processor communications, and a system data bus adapted to permit data exchange between system resources, the busses, the engines, and the processors.

22. The multi-standard video decode and encode system of claim 21, wherein the prediction engine includes a forward motion prediction module and an inverse motion prediction module.

23. The multi-standard video decode and encode system of claim 21, wherein the transform engine includes a forward quantization and transform module and an inverse quantization and transform module.

24. The multi-standard video decode and encode system of claim 21 comprising:
a bit stream decode processor; and
a bit stream encode/rate control processor, wherein the processors are coupled to the inter-processor communications bus.

25. The multi-standard video decode and encode system of claim 22, wherein the forward motion prediction module performs both inter-frame prediction and intra-frame prediction, wherein a quantized image is sent to the transform engine.

26. The multi-standard video decode and encode system of claim 25, wherein the quantized image is reconstructed through an inverse quantization/inverse transform module adapted to calculate residual or prediction error.

27. The multi-standard video decode and encode system of claim 26, wherein an optional deblocking filter can be utilized.

28. The multi-standard video decode and encode system of claim 26, wherein the predicted results and the prediction errors are entropy coded with a bitstream syntax defined by a chosen standard.

29. The multi-standard video decode and encode system of claim 21, wherein motion estimation design is divided into software and hardware functions.

30. The multi-standard video decode and encode system of claim 29, wherein the hardware design is responsible for pixel comparison between a current image and reference images, and for sub-pixel interpolation,

31. The multi-standard video decode and encode system of claim 29, wherein the software design is responsible for search strategy, block-size determination, and rate-distortion optimization.

32. The multi-standard video decode and encode system of claim 21 comprising a video bridge operably coupled to the system data bus and to an audio subsystem.

33. The multi-standard video decode and encode system of claim 21 comprising a video input and video output module adapted to receive and transmit video signals, wherein the video input and video output module is operably coupled to the system data bus.

34. The multi-standard video decode and encode system of claim 33, wherein the video signals are at least one of:
an H.261 signal;
an H.263 signal;
an H.264 signal;
an MPEG-1 signal;
an MPEG-2 signal;
an MPEG-4 signal;
a JPEG signal; and
other video signals.

35. A method for decoding an H.264/AVC signal, comprising:
receiving a coded bitstream by a bitstream decoder; and
entropy decoding the coded bitstream, inverse scanning the coded bitstream, and acting as a logical multiplexer by the bitstream decoder thereby generating a plurality of motion vectors, a set of quantized coefficients, or an intra prediction mode indicator.

36. The method of claim 35 comprising producing a set of quantized coefficients.

37. The method of claim 36 comprising receiving the quantized coefficients by an inverse quantization module and performing a reverse quantization on the coefficients.

38. The method of claim 37 comprising generating de-quantized coefficients.

39. The method of claim 38 comprising receiving the de-quantized coefficients by an inverse transform module, and producing a set of residual values or prediction errors.

40. The method of claim 39, wherein the prediction errors are added with predicted macroblock pixels in an adder block when they are available.

41. The method of claim 40 comprising receiving the motion vectors by a variable sized motion compensation block.

42. The method of claim 41 comprising fetching referenced macroblocks from at least one previously reconstructed frame based on the motion vectors.

43. The method of claim 42 comprising producing an inter-predicted macroblock.

44. The method of claim 43 comprising receiving the inter-predicted macroblock by an adder block for reconstruction with the residual values.

45. The method of claim 44 comprising, if the bitstream decoder detects an intra-predicted macroblock, transmitting a chosen intra prediction mode to an inverse intra-prediction module.

46. The method of claim 45 comprising reproducing the intra-predicted macroblock by applying the inverse intra-prediction.

47. The method of claim 46 comprising receiving the intra-predicted macroblock by the adder block for reconstruction with the residual values.

48. The method of claim 47 comprising, once the macroblock is reconstructed, performing at least one of:
passing a portion of the macroblock pixels to the inverse intra-prediction module for future prediction use; and
passing a portion of the macroblock pixels to a deblocking filter module for a filter operation.

49. The method of claim 48 comprising writing back the filtered, reconstructed macroblock to a current reconstructed frame which is ready for display.

50. A computer readable medium comprising instructions for:
receiving a coded bitstream; and
entropy decoding the coded bitstream, inverse scanning the coded bitstream, and acting as a logical multiplexer thereby generating a plurality of motion vectors, a set of quantized coefficients, and an intra prediction mode indicator.
